(19) United States
(12) Patent Application Publication
(10) Pub. No.: US 2002/0085731 A1
(43) Pub. Date: Jul. 4, 2002

(54) Electroacoustic waveguide transducing

(76) Inventor: J. Richard Aylward, Ashland, MA (US)

Correspondence Address: CHARLES HIEKEN, Fish & Richardson P.C., 225 Franklin Street, Boston, MA, 02110-2804, US

(21) Appl. No.: 09/753,167

(22) Filed: Jan. 2, 2001

(51) Int. Cl. H04R 1/02; H04R 1/20

(52) U.S. Cl. 381/349; 381/348; 381/352

(57) ABSTRACT

An acoustic waveguide system, having source of acoustic radiation and a source of opposing acoustic radiation. An acoustic waveguide has an open end and an interior. A first acoustic driver having a first radiating surface and a second radiating surface is arranged and constructed so that the first radiating surface radiates sound waves into free air and the second radiating surface radiates sound waves into the acoustic waveguide so that sound waves are radiated at the open end. A source of opposing sound waves in the acoustic waveguide opposes a predetermined spectral component of the sound waves radiated into the acoustic waveguide to reduce the acoustic radiation of the predetermined spectral component from the acoustic waveguide.

### CROSS-REFERENCE TO RELATED APPLICATIONS

Not applicable.

### FEDERALLY SPONSORED RESEARCH OR DEVELOPMENT

Not applicable.

### BACKGROUND OF THE INVENTION

For background, reference is made to U.S. Pat. No. 4,628,528, copending application Ser. No. 09/146,622 filed Sep. 3, 1998, for WAVEGUIDE ELECTROACOUSTICAL TRANSDUCING and the commercially available Bose Wave radio, Wave radio/CD and ACOUSTIC WAVE music systems incorporated herein by reference.

### BRIEF SUMMARY OF THE INVENTION

It is an important aspect of the invention to provide improved electroacoustic waveguide transducing.

According to the invention, an electroacoustic waveguide transducing system includes an acoustic waveguide having an open end and an interior. A first electroacoustic transducer in the waveguide has a first radiating surface facing free air and a second radiating surface facing the acoustic waveguide interior so that sound waves may radiate through the open end. There is a spectral attenuator in the acoustic waveguide to attenuate the acoustic radiation of a predetermined spectral component from the acoustic waveguide.

In another aspect of the invention, the electroacoustic driver is positioned in the acoustic waveguide so that there is null at a null frequency.

In another aspect of the invention, there are a plurality of electroacoustic transducers. A first of the acoustic drivers is placed in the wall of the acoustic waveguide. The transducers are placed in the waveguide typically separated by half the effective acoustic waveguide wavelength.

In another aspect of the invention, there is an acoustic low-pass filter, coupling the electroacoustic transducer and the acoustic waveguide.

In still another aspect of the invention, a method for operating an acoustic waveguide having an open end and a closed end and a wall connecting the open end and the closed end, includes radiating acoustic energy into the acoustic waveguide and significantly attenuating acoustic radiation at the frequency at which the wavelength is equal to the effective wavelength of the acoustic waveguide.

Other features, objects, and advantages will become apparent from the following detailed description, which refers to the following drawing in which:

### BRIEF DESCRIPTION OF THE SEVERAL VIEWS OF THE DRAWING

FIG. 1 is a diagrammatic cross section of a prior art electroacoustic waveguide transducer characterized by a dip frequency;

FIG. 2 is a diagrammatic cross section of an electroacoustical waveguide transducing system according to the invention;

FIG. 3 is a diagrammatic cross section of second embodiment of the invention with a plot of pressure or volume velocity at points along the waveguide, for illustrating a feature of the invention;

FIG. 4 is a diagrammatic cross section of a third embodiment of the invention;

FIG. 5 is a diagrammatic cross section of a fourth embodiment of the invention;

FIG. 6 is a diagrammatic cross section of a generalized form of a fifth embodiment of the invention;

FIG. 7 is a diagrammatic cross section of a sixth embodiment of the invention;

FIG. 8 is a wire frame drawing of an embodiment of the invention;

FIG. 9 is a diagrammatic cross section of a second embodiment of the invention; and

FIG. 10 is a diagrammatic cross section of another embodiment of the invention.

### DETAILED DESCRIPTION

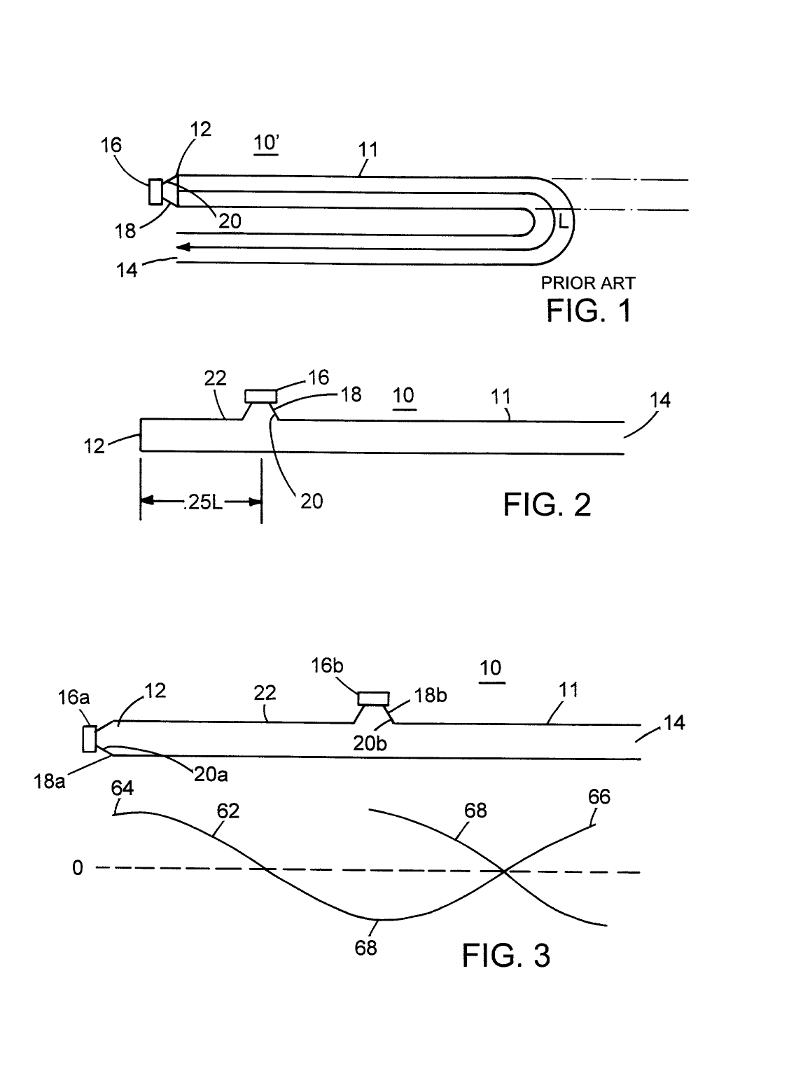

With reference now to the drawing and more particularly to FIG. 1, there is shown a prior art electroacoustical waveguide transducing system helpful in understanding acoustic waveguide transducing. Electroacoustical waveguide transducing system 10′ includes an acoustic waveguide 11 that has a terminal end 12 and an open end 14. Mounted in the waveguide, at terminal end 12, is electroacoustical driver 16. When electroacoustical driver 12 radiates a sound wave, it radiates a front wave into free air surrounding the waveguide and a back wave into the waveguide. At some first frequency ƒ herein referred to as the “dip frequency,” above the quarter-wave resonance frequency, the combined output of the waveguide and the output of the free air radiation have a phase and amplitude relation such that the combined output of the waveguide system has a “dip” or local minimum, herein referred to as an “acoustic dip.” If the waveguide has a constant cross section, the dip frequency is approximately the frequency corresponding to a wave with a wavelength equal to the effective wavelength (including end effects) of the waveguide. If the waveguide does not have a constant cross section, the dip frequency may be determined by mathematical calculation, computer modeling, or empirically. In a constant cross section waveguide, a similar dip occurs when the sound waves have a frequency of a multiple of ƒ, such as 2ƒ, 3ƒ, 4ƒ, 5ƒ (so that the wavelength L=2 wavelengths, 3 wavelengths, 4 wavelengths, 5 wavelengths and so on). In a waveguide having a varying cross section, a similar acoustic dip occurs at a frequency ƒ and at multiples of frequency ƒ, but the multiples may not be integer multiples off and the “dip” may not have the same steepness, width, or depth as the “dip” at frequency ƒ. Typically, the dip at frequency ƒ is the most significant.

Referring now to FIG. 2, there is shown an electroacoustical waveguide system 10 according to the invention. Waveguide system 10 includes an acoustic waveguide 11 that is a tubular structure that has a terminal end 12 and an open end 14. An “acoustic waveguide” as used herein, is similar to the tube or low loss acoustic transmission line disclosed in U.S. Pat. No. 4,628,528 or in the Bose Wave radio/CD. Terminal end 12 is terminated by an acoustically reflective surface. Mounted in a wall 22 of waveguide 11 is an acoustic energy source, in this case, an acoustic driver 16. Acoustic driver 16 has one radiating surface (in this case back side 18) of the acoustic driver facing free air and the other side (in this case front side 20) of the acoustic driver facing into acoustic waveguide 11. Acoustic driver 16 is mounted at a point such that the reflected sound wave in the waveguide is out of phase with the unreflected radiation in the waveguide from the acoustic driver and therefore the unreflected and reflected radiation oppose each other. As a result of the opposition, there is significantly reduced radiation from acoustic waveguide 11. Since there is significantly reduced radiation from the acoustic waveguide 11, the sound waves radiated into free air by the back side 16 of acoustic driver 16 are not opposed by radiation from waveguide 11, and the null at the dip frequency ƒ at which the wavelength equal L (and at the even multiples of frequency ƒ) is greatly reduced. In a waveguide of substantially constant cross section, if acoustic driver 16 is placed at a point 0.25L, where L is the effective length of the waveguide including end effects, from the terminal end 12 of the waveguide, the reflected sound wave is out of phase with the unreflected radiation from the acoustic driver at the dip frequency.

Referring to FIG. 3, there is shown a second waveguide system according to the invention and a plot of pressure at points along the length of the waveguide. Waveguide system 10 includes an acoustic waveguide 11 that is a tubular structure that has a terminal end 12 and an open end 14. Acoustically coupled to the waveguide is an acoustic energy source, which, in the implementation of FIG. 3 includes two acoustic drivers 16a and 16b. First acoustic driver 16a is mounted in the terminal end 12, with one radiating surface (in this case back side 18a) of the first acoustic driver 16a facing free air and the other radiating surface (in this case front side 20a) of the first acoustic driver 16a facing into the acoustic waveguide 11. Second acoustic driver 16b is mounted in a wall 22 of the waveguide 11, with one radiating surface (in this case back side 18b) of the second acoustic driver 16b facing free air and the other radiating surface (in this case front side 20b) of the acoustic driver facing into the acoustic waveguide 11. The second acoustic driver 16b is mounted at the acoustic midpoint (as defined below) of the waveguide. First and second acoustic drivers 16a and 16b are connected in phase to the same signal source (signal source and connections not shown).

When first acoustic driver 16a radiates a sound wave with a wavelength equal to L, the pressure and volume velocity resulting from the radiation of driver 16a in the waveguide vary as curve 62, with the pressure (or volume velocity) in-phase and of approximately equal amplitude 64, 66, at the front side 20a of driver 16a and at the open end 14 of the waveguide 11. At a point 68 between front side 20a of the driver and the open end 14, the pressure or volume velocity is equal to, and out of phase with, the pressure or volume velocity at points 64, 66. Point 68 will be referred to as the effective midpoint or the acoustic midpoint of the waveguide. Second acoustic driver 16b is connected in phase to the same signal source as first acoustic driver 16a. When first acoustic driver 16a radiates a sound wave with a wavelength equal to L, second acoustic driver 16b also radiates a sound wave with a wavelength equal to L, the pressure or volume velocity resulting from driver 16b varies as curve 68, in phase opposition to curve 62. The pressure or volume velocity waves from the two acoustic drivers therefore oppose each other, and there is significantly reduced radiation from the acoustic waveguide 11. Since there is significantly reduced radiation from the acoustic waveguide 11, the sound waves radiated into free air by the back side 18a of first acoustic driver 16a and the back side 18b of second acoustic driver 16b are not opposed by radiation from the waveguide.

If the waveguide has little or no variation in the cross-sectional area of the waveguide 11 as in FIG. 3, the effective midpoint of the waveguide is typically close to the geometric midpoint of the waveguide. In waveguide systems in which the waveguide does not having a uniform cross-sectional area, the effective midpoint of the waveguide may not be at the geometric midpoint of the waveguide, as described below in the discussion of FIG. 7. For waveguides in which the waveguide does not have a uniform cross section, the effective midpoint may be determined by mathematical calculation, by computer modeling, or empirically.

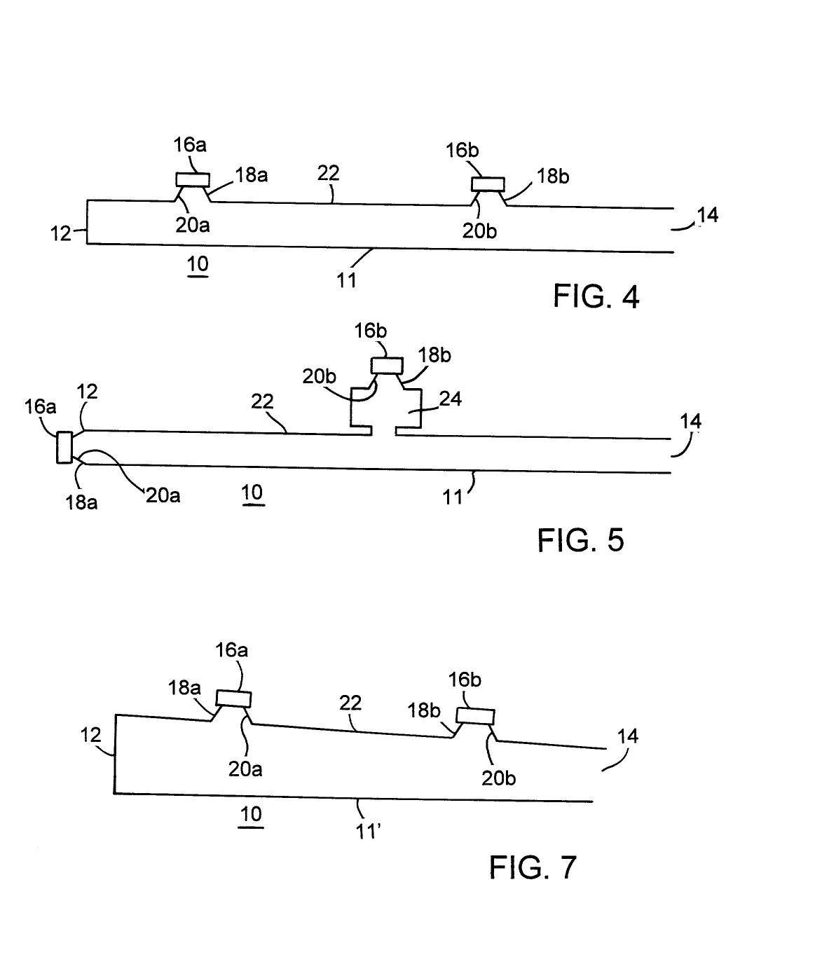

Referring to FIG. 4, there is shown a third waveguide system according to the invention. Waveguide system 10 includes an acoustic waveguide 11 that is a tubular structure that has a terminal end 12 and an open end 14. Terminal end 12 is terminated by an acoustically reflective surface. Mounted in a wall 22 of the waveguide 11 is a first acoustic driver 16a at a position between the terminal end 12 and the effective midpoint of the waveguide, with one radiating surface (in this case back side 18a) of the first acoustic driver 16a facing free air and the other radiating surface (in this case front side 20a) of the first acoustic driver 16a facing into acoustic waveguide 11. Additionally, a second acoustic driver 16b is mounted in a wall 22 of the waveguide 11, with one radiating surface (in this case back side 18b) of the second acoustic driver 16b facing free air and the other radiating surface (in this case front side 20b) of the acoustic driver facing into acoustic waveguide 11. The second acoustic driver 16b is mounted at a point between the first acoustic driver 16a and the open end 14 of the waveguide, and is electronically coupled in phase to the same audio signal source as first acoustic driver 16a. The mounting point of the second waveguide 16b is set such that radiation of second acoustic driver 16b opposes radiation from first acoustic driver 16a when acoustic drivers 16a and 16b radiate sound waves of wavelength equal to the effective length of waveguide 11. As a result of the opposition, there is significantly reduced radiation from acoustic waveguide 11. Since there is significantly reduced radiation from the acoustic waveguide 11, the sound waves radiated into free air by the back side 18a of first acoustic driver 16a and the back side 18b of second acoustic driver 16b are not opposed by radiation from the waveguide.

If the waveguide has a relatively uniform cross section, the distance between first acoustic driver 16a and second acoustic driver 16b will be about a 0.5L, where L is the effective length of the waveguide. For waveguides with nonuniform cross-sectional areas, the distance between second acoustic driver 16b and first acoustic driver 16a can be determined by mathematical calculation, by computer modeling, or empirically.

Referring to FIG. 5, there is shown a fourth waveguide system according to the invention. Waveguide system 10 includes an acoustic waveguide 11 that is a tubular structure that has a terminal end 12 and an open end 14. Terminal end 12 is terminated by a first acoustic driver 16a mounted in the end, with one radiating surface (in this case back side 18a) of the first acoustic driver 16a facing free air and the other radiating surface (in this case front side 20a) of the first acoustic driver 16a facing into the acoustic waveguide 11. Additionally, a second acoustic driver 16b is mounted in a wall 22 of waveguide 11, with one radiating surface (in this case back side 18b) of the second acoustic driver 16b facing free air and the other radiating surface (in this case front side 20b) of acoustic driver acoustically coupled to the acoustic waveguide 11 by acoustic volume 24 at a point such that acoustic radiation from second driver 16b and acoustic radiation from first driver 16a oppose each other when first and second drivers 16a and 16b radiate sound waves with a wavelength equal to the effective length L or waveguide 11. First and second acoustic drivers 16a and 16b are connected in phase to the same signal source (signal source and connections not shown). As a result of the opposition, there is significantly reduced radiation from acoustic waveguide 11. Since there is significantly reduced radiation from acoustic waveguide 11, the sound waves radiated into free air by the back side 18a of first acoustic driver 16a and the back side 18b of second acoustic driver 16b of the acoustic driver are not opposed by radiation from the waveguide. Acoustic volume 24 acts as an acoustic low-pass filter so that the sound radiation from second acoustic driver 16b into acoustic waveguide 11 is significantly attenuated at higher frequencies. The embodiment of FIG. 5 damps output peaks at higher frequencies.

The principles of the embodiment of FIG. 5 can be implemented in the embodiment of FIG. 4 by coupling one of acoustic drivers 16a or 16b by an acoustic volume such as acoustic volume 24 of FIG. 5.

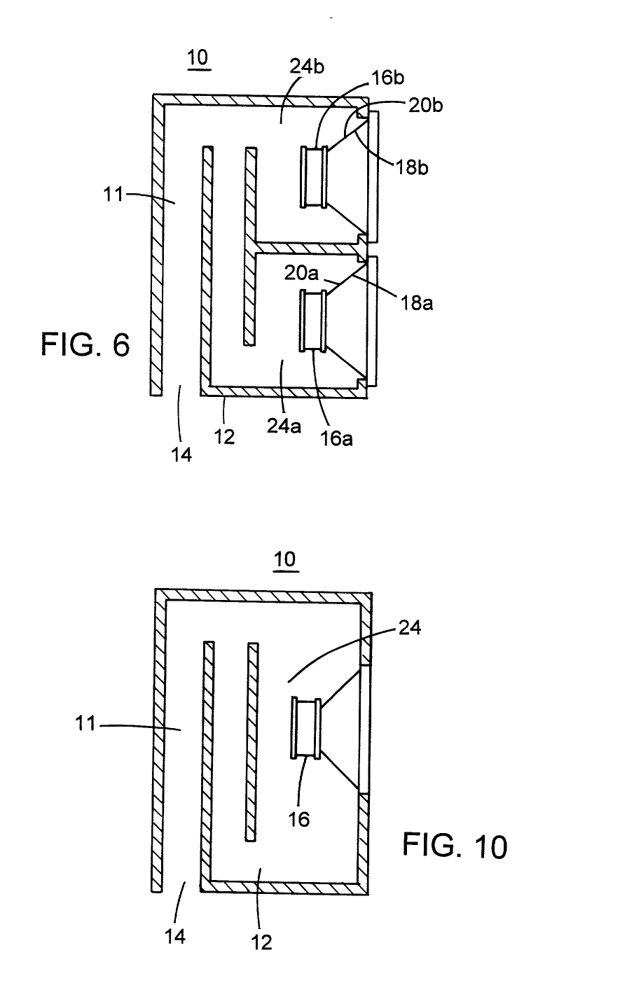

Referring now to FIG. 6, there is shown another embodiment of the invention, combining the principles of the embodiments of FIGS. 3 and 5. Waveguide system 10 includes an acoustic waveguide 11 that is a tubular structure that has a terminal end 12 and an open end 14. Terminal end 12 is terminated by a first acoustic driver 16a mounted in the end, with one radiating surface (in this case front side 20a) of the first acoustic driver 16a facing free air and the other radiating surface (in this case back side 18a) of the first acoustic driver 16a acoustically coupled to the terminal end 12 of acoustic waveguide 11 by acoustic volume 24a. Additionally, a second acoustic driver 16b is mounted in a wall 22 of waveguide 11, with one radiating surface (in this case front side 20b) of the second acoustic driver 16b facing free air and the other radiating surface (in this case back side 18b) of the acoustic driver acoustically coupled to acoustic waveguide 11 by acoustic volume 24b at the effective midpoint of the waveguide. First and second acoustic drivers 16a and 16b are connected in phase to the same signal source (signal source and connections not shown). When first and second acoustic drivers 16a and 16b radiate a sound wave having a frequency equal to the opposition frequency, the sound wave radiated by second acoustic driver 16b and the sound wave radiated by acoustic driver 16a oppose each other. As a result of the opposition, there is significantly reduced radiation from acoustic waveguide 11. Since there is little radiation from the acoustic waveguide 11, the sound waves radiated into free air by the front side 20a of first acoustic driver 16a and the front side 20b of second acoustic driver 16b of the acoustic driver are not opposed by radiation from the waveguide, and the cancellation problem at the cancellation frequency ƒ (and at the even multiples of frequency ƒ) is greatly mitigated. Acoustic volumes 24a and 24b act as acoustic low-pass filters so that the sound radiation into the waveguide is significantly attenuated at higher frequencies, damping the high frequency output peaks.

The principles of the embodiment of FIG. 6 can be implemented in the embodiment of FIG. 4 by coupling acoustic drivers 16a and 16b to waveguide 11 by acoustic volumes such as the acoustic volumes 24a and 24b of FIG. 6.

Referring now to FIG. 7, there is shown another embodiment of the invention. Waveguide system 10 includes an acoustic waveguide 11′ that is tapered as disclosed in U.S. patent application Ser. No. 09/146,662 and embodied in the Bose Wave radio/CD. Terminal end 12 is terminated by an acoustically reflective surface. Mounted in a wall 22 of waveguide 11 is a first acoustic driver 16a mounted at a position between the terminal end 12 and the effective midpoint of the waveguide. First acoustic driver 16a may also be mounted in terminal end 12. One radiating surface (in this case back side 18a) of the first acoustic driver 16a faces free air, and the other radiating surface (in this case front side 20a) of the first acoustic driver 16a faces into the acoustic waveguide 11. Additionally, a second acoustic driver 16b is mounted in a wall 22 of the waveguide 11, with one radiating surface (in this case back side 18b) of the second acoustic driver 16b facing free air and the other radiating surface (in this case front side 20b) of the acoustic driver facing into the acoustic waveguide 11. First and second acoustic drivers 16a and 16b are connected in phase to the same signal source (signal source and connections not shown). The second acoustic driver 16b is spaced by a distance such that when first and second acoustic drivers 16a and 16b radiate sound waves of a frequency equal to the dip frequency into waveguide 11, they oppose each other. As a result of the opposition, there is significantly reduced radiation from the acoustic waveguide 11. Since there is significantly reduced radiation from acoustic waveguide 11, the sound waves radiated into free air by the back side 18a of first acoustic driver 16a and the back side 18b of second acoustic driver 16b of the acoustic driver are not opposed by radiation from the waveguide.

In a tapered waveguide, or other waveguides with nonuniform cross sections, the effective midpoint (as defined in the discussion of FIG. 3) may differ from the geometric halfway point of the waveguide. For waveguides with nonuniform cross sections the effective midpoint may be determined by mathematical calculation, by computer simulation, or empirically.

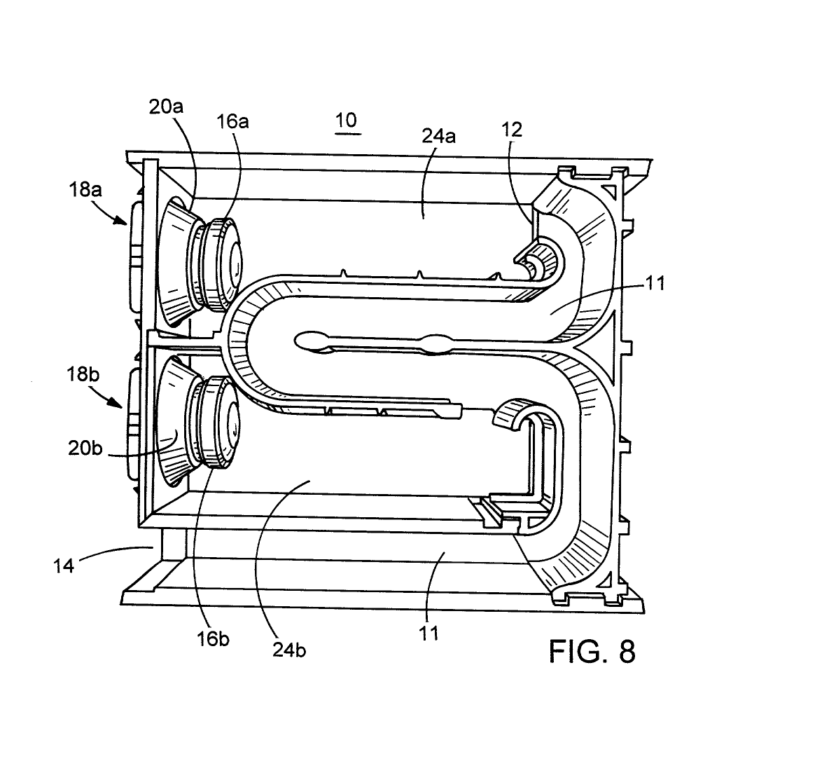

Referring now to FIG. 8, there is shown a cutaway perspective view of an exemplary electroacoustical waveguide system according to the invention. The waveguide system of FIG. 8 uses the implementation of FIG. 6, with the FIG. 8 implementation of the elements of FIG. 6 using common identifiers. In the implementation of FIG. 8, waveguide 11 has a substantially uniform cross sectional area of 12.9 square inches and a length of 25.38 inches. The acoustic volumes 24a and 24b have a volume of 447 cubic inches and 441 cubic inches, respectively, and the acoustic drivers are 5.25 inch 3.8 ohm drivers available commercially from Bose Corporation of Framingham, Mass.

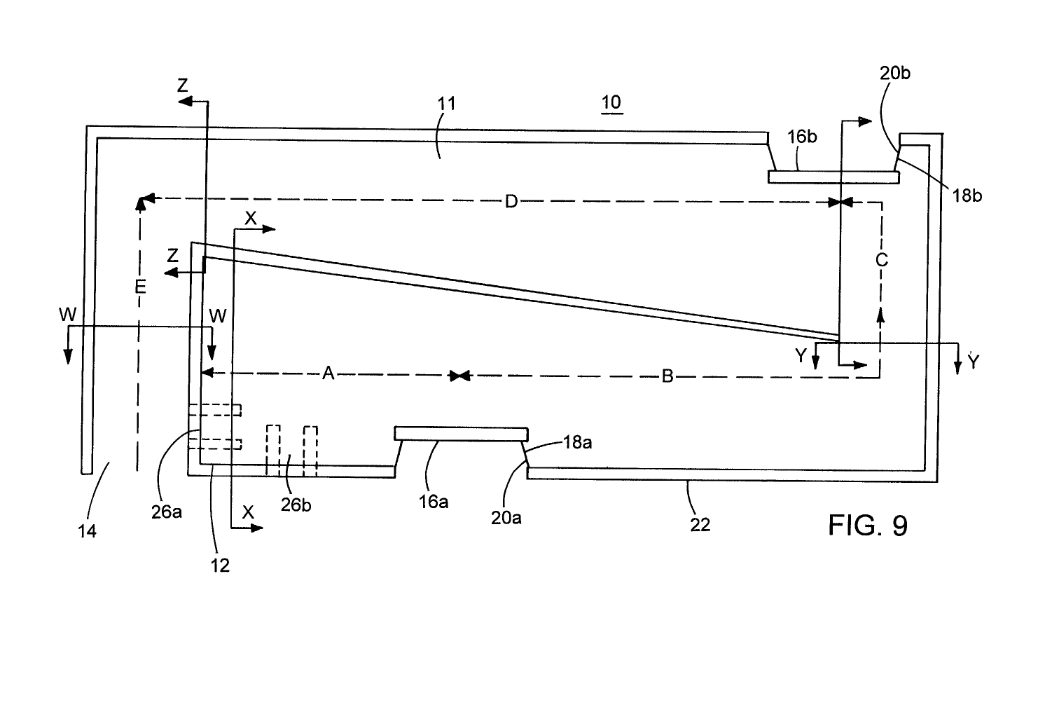

Referring to FIG. 9, there is shown a cross section of another electroacoustical waveguide system according to the invention. In FIG. 9, identifiers refer to common elements of FIGS. 2-8. Waveguide 11 has two tapered sections, with a first section 11a having a cross section of 36.0 square inches at section X-X, 22.4 square inches at section Y-Y, 28.8 square inches at section Z-Z, 22.0 square inches at section W-W, and 38.5 square inches at section V-V. Length A is 10.2 inches, length B is 27.8 inches, length C is 4.5 inches, length D is 25.7 inches, and length E is 10.4 inches. Acoustic drivers 16a and 16b are 6.5 inch woofers available commercially from Bose Corporation of Framingham, Mass. To adjust acoustic parameters of the waveguide system, there may be an optional port 26a or 26b (dotted lines) and there may be acoustic absorbent material in the waveguide 11, such as near the terminal end 12 of the waveguide 11.

Referring to FIG. 10, there is shown another embodiment of the invention. The embodiment of FIG. 10 uses the topology of the embodiment of FIG. 8, but is constructed and arranged so that a single acoustic driver 16 performs the function of both acoustic drivers 16a and 16b of the embodiment of FIG. 6. If desired, the acoustic driver 16 can be replaced by more than one acoustic driver coupled to waveguide 11 by a common acoustic volume 24.

Other embodiments are within the claims.

What is claimed is:

1. An electroacoustic waveguide system, comprising:
an acoustic waveguide having an open end and an interior;
a first acoustic driver having a first radiating surface and a second radiating surface, constructed and arranged so that said first radiating surface radiates sound waves into free air and said second radiating surface radiates sound waves into said acoustic waveguide so that sound waves are radiated at said open end; and
a source of opposing sound waves in said acoustic waveguide for opposing a predetermined spectral component of said sound waves radiated into said acoustic waveguide to oppose the acoustic radiation of said predetermined spectral component from said acoustic waveguide.

2. An electroacoustic waveguide system in accordance with claim 1, further comprising an acoustic port, coupling said interior with free air.

3. An electro acoustic waveguide system in accordance with claim 1, wherein said predetermined spectral component comprises the opposition frequency.

4. An electroacoustic waveguide system in accordance with claim 1, wherein said source of opposing sound waves comprises a reflective surface inside said acoustic waveguide, positioned so that sound waves reflected from said reflective surface oppose said sound waves radiated directly into said acoustic waveguide by said second radiating surface.

5. An electroacoustic waveguide system in accordance with claim 1, wherein said source of opposing sound waves comprises a second acoustic driver arranged and constructed to radiate sound waves into said acoustic waveguide.

6. An electroacoustic waveguide system in accordance with claim 5, further comprising an acoustic port, coupling said interior with free air.

7. An electroacoustic waveguide system in accordance with claim 6, wherein said acoustic waveguide has a closed end and said acoustic port is positioned between said first acoustic driver and said closed end of said acoustic waveguide.

8. An electroacoustic waveguide system in accordance with claim 1, wherein said predetermined spectral component comprises a dip frequency at which said waveguide system produces an acoustic null, absent said source of opposing sound waves.

9. An electroacoustic waveguide system in accordance with claim 8, wherein said source of opposing sound waves comprises a reflective surface inside said acoustic waveguide, positioned so that sound waves reflected from said reflective surface opposes said sound waves radiated directly into said acoustic waveguide by said second radiating surface.

10. An electroacoustic waveguide system in accordance with claim 8, wherein said source of opposing sound waves comprises a second acoustic driver arranged and constructed to radiate sound waves into said acoustic waveguide.

11. An electroacoustic waveguide system, comprising:
an acoustic waveguide having an open end and a closed end and further having an effective length;
an acoustic driver for radiating sound waves into said waveguide, positioned in said acoustic waveguide so that there is an acoustic null at said open end at a dip frequency.

12. An electroacoustic waveguide system in accordance with claim 11, said acoustic waveguide having a substantially constant cross section, wherein said acoustic driver is positioned at a distance substantially 0.25L from said closed end of said waveguide, where L is the effective length of said waveguide.

13. An electroacoustic waveguide system in accordance with claim 12, wherein said closed end is a surface that is acoustically reflective at said dip frequency.

14. An electroacoustic waveguide system comprising:
an acoustic waveguide having an open end and a closed end and a wall connecting said open end and said closed end;
a plurality of acoustic drivers, each having a first radiating surface and a second radiating surface;
wherein a first of said acoustic drivers is placed in said wall of said acoustic waveguide so that said first radiating surface of said first acoustic driver radiates into said acoustic waveguide and said second radiating surface of said first acoustic driver radiates into free air.

15. An electroacoustic waveguide system in accordance with claim 14, wherein a second of said acoustic drivers is positioned in said closed end of said acoustic waveguide.

16. An electroacoustic waveguide system in accordance with claim 14, wherein a second of said plurality of acoustic drivers is placed in said wall of said acoustic waveguide so that said first radiating surface of said second driver radiates into said acoustic waveguide and said second radiating surface of said second acoustic driver radiates into free air.

17. A method for radiating with the apparatus of claim 14 by combining radiation of said plurality of acoustic drivers to produce an acoustic null at the open end of said waveguide at a dip frequency.

18. An electroacoustic waveguide system comprising:
an acoustic waveguide;
an acoustic driver; and
an acoustic low-pass filter intercoupling said acoustic driver and said acoustic waveguide.

19. An electroacoustic waveguide system in accordance with claim 18, wherein said acoustic low pass-filter comprises an acoustic compliance between said acoustic driver and said acoustic waveguide.

20. An electroacoustic waveguide system comprising:
an acoustic waveguide having an open end and a closed end and an effective midpoint;
a plurality of acoustic drivers; and
an acoustic compliance acoustically coupling a first of said plurality of acoustic drivers and said acoustic waveguide.

21. An electroacoustic waveguide system in accordance with claim 20 wherein a first of said plurality of acoustic drivers is positioned at approximately said effective midpoint.

22. An electroacoustic waveguide system in accordance with claim 20,
said acoustic waveguide having a substantially constant cross section,
wherein a first of said plurality of acoustic drivers is positioned at a distance substantially 0.25L from said closed end, where L is the effective length of said acoustic waveguide,
and wherein a second of said plurality of acoustic drivers is positioned substantially 0.75L from said closed end,
and an acoustic compliance between said second acoustic driver and said waveguide.

23. An electroacoustic waveguide system comprising:
an acoustic waveguide having a substantially constant cross section; and
a plurality of acoustic drivers placed in said acoustic waveguide so at least two of said acoustic drivers are substantially 0.5L apart where L is the effective length of the waveguide.

24. An electroacoustic waveguide system in accordance with claim 23 wherein a first of said plurality of acoustic drivers is placed at a position substantially 0.25L from said closed end and a second of said acoustic drivers is placed at a position substantially 0.75L from said closed end, where L is the effective length of the waveguide.

25. A method for operating an acoustic waveguide having an open end and a closed end and a wall connecting said open end and said closed end, comprising,
radiating acoustic energy into said acoustic waveguide; and
significantly opposing acoustic radiation at a predetermined dip frequency.

26. A method for operating an acoustic waveguide in accordance with claim 25, wherein said opposing acoustic radiation comprises providing opposing acoustic radiation in said acoustic waveguide.

27. A method for operating an acoustic waveguide in accordance with claim 26, wherein said providing opposing acoustic radiation comprises reflecting said radiated acoustic energy off an acoustically reflective surface inside said acoustic waveguide so that said reflected acoustic energy opposes the acoustic energy radiated into said waveguide.

28. A method for operating an acoustic waveguide in accordance with claim 26, wherein said providing opposing acoustic radiation comprises radiating, by a second acoustic driver, said opposing acoustic energy into said acoustic waveguide.
